(19) United States
(12) Patent Application Publication
(10) Pub. No.: US 2026/0065805 A1
(43) Pub. Date: Mar. 5, 2026

(54) CASCADE DUAL-DECODER BASED SIGN LANGUAGE PRODUCING DEVICE, METHOD, AND RECORDING MEDIUM

(71) Applicant: AJOU UNIVERSITY INDUSTRY-ACADEMIC COOPERATION FOUNDATION, Suwon-si (KR)

(72) Inventors: Tae-Sun CHUNG, Seongnam-si (KR); Xiaohan MA, Seongnam-si (KR); Rize JIN, Seongnam-si (KR)

(21) Appl. No.: 19/319,509

(22) Filed: Sep. 4, 2025

(30) Foreign Application Priority Data
Sep. 4, 2024 (KR) 10-2024-0119674

(51) Int. Cl. G09B 21/00

(52) U.S. Cl. CPC G09B 21/009

(57) ABSTRACT

Provided is a cascade dual-decoder based sign language producing device and method, and the device includes a text encoder configured to input a text sequence prepared in advance into at least one encoder block to output contextual features, a hand pose decoder configured to input the contextual features output from the text encoder and a hand pose sequence prepared in advance into at least one attention layer to output a hand-channel sign pose feature that aligns text and a hand motion, and a sign pose decoder configured to input the contextual features output from the text encoder and the hand pose decoder, the hand-channel sign pose feature, and a sign pose sequence prepared in advance into at least one attention layer to output a full-channel sign pose sequence in which the sign language is implemented as a hand element and a non-hand element.

### CROSS REFERENCE TO RELATED APPLICATIONS

This application claims priority to Korean Patent Application No. 10-2024-0119674, filed on Sep. 4, 2024, in the Korean Intellectual Property Office, which is incorporated by reference herein in its entirety.

### FIELD OF THE INVENTION

The present disclosure relates to a device, a method, and a recording medium for producing a sign language based on a cascade dual-decoder.

### BACKGROUND OF THE RELATED ART

The World Health Organization (WHO) estimates that about 5% of the world's population suffers from hearing loss of greater than moderate severity. Although not used by all deaf people, sign language is the primary medium of communication for those with hearing impairments and is a natural language present in many societies around the world.

Similar to spoken language, sign language indicates the expected levels of organization in natural language, phonetic, morphological, syntactic, semantic, and practical. The main difference between spoken language and sign language is that sign language uses a combination of hand elements (hand shape, position, movement and direction) and non-hand elements (facial expression, mouth, body movement) to convey information. Due to this asynchronous multi-articulatory characteristic, sign language shows not only temporal context dependence of natural language but also spatial context dependence expected from visual understanding.

Meanwhile, the Sign Language Production (SLP) model refers to an operation of producing a sign language representation in a text representation in the form of a term or word sequence, and in the SLP model, the sign language may be expressed in various ways such as a sign pose sequence (skeletal joint coordinates), animation, and realistic video.

However, due to differences in tokenization and phonological properties of voice language and sign language, the SLP model has difficulty learning mapping from simple text to complex sign language, including multi-channel visual variations.

In addition, SLP models trained solely for spatial regression tend to frequently regress toward the average hand shape rather than producing various sign language motions. As a result, the generated sign language movement may lack sufficiency, precision and naturalness compared to the actual sign language expressions, and significantly lack the importance of subtle differences in hand expressions.

Therefore, research on how to generate more accurate and expressive sign language is needed.

### SUMMARY OF THE INVENTION

The present disclosure has been devised to solve the above problems, and an object of the present disclosure is to provide a cascade dual-decoder based sign language producing device, method, and recording medium.

In order to achieve the objective, a sign language producing device according to an aspect of an exemplary embodiment may include a text encoder configured to input a pre-prepared text sequence to at least one encoder block to output a contextual feature, a hand pose decoder configured to input the contextual feature output from the text encoder and a pre-prepared hand pose sequence to at least one attention layer to output a hand channel sign pose feature that aligns a text and a hand movement, and a sign pose decoder configured to input the contextual feature output from the text encoder and the hand pose decoder, the hand channel sign pose feature and a pre-prepared sign pose sequence to at least one attention layer to output a full channel sign pose sequence in which the sign language is implemented as a hand element and a non-hand element.

In another embodiment, the sign language producing method by the cascade dual-decoder based sign language producing device includes inputting, by a text encoder, a pre-prepared text sequence into at least one encoder block to output a contextual feature, inputting, by a hand pose decoder, the contextual feature output from the text encoder and a pre-prepared hand pose sequence into at least one attention layer to output a hand channel sign pose feature that aligns a text and a hand motion, and inputting, by a sign pose decoder, the contextual feature output from the text encoder and the hand pose decoder, the hand channel sign pose feature and a pre-prepared sign pose sequence into at least one attention layer to output a full channel sign pose sequence in which the sign language is implemented as a hand element and a non-hand element.

According to an aspect of the present disclosure described above, by providing a cascade dual-decoder based sign language producing device, method, and recording medium, it is possible to generate an overall sign language expression by simultaneously considering a hand element and a non-hand element, thereby greatly improving the accuracy and naturalness of the sign language expression and better processing complex sign language grammar.

In addition, since the two decoders perform different roles and complement each other, the expressiveness of the sign language producing device is increased and the efficiency of the work performed by each decoder is increased.

In addition, a more expressive sign language can be created through the space-time loss function.

### BRIEF DESCRIPTION OF THE DRAWINGS

FIG. 1 is a device diagram illustrating an internal block of a cascade dual-decoder based sign language producing device according to an embodiment of the present disclosure.

FIG. 2 is a diagram illustrating a detailed configuration of the sign language producing device of FIG. 1.

FIG. 3 is a flowchart illustrating an operation of the sign language producing device based on a cascade dual-decoder according to the other embodiment of the present disclosure.

### DETAILED DESCRIPTION OF THE PREFERRED EMBODIMENT

A detailed description of the present disclosure, which will be described later, refers to the accompanying drawings, which illustrate specific embodiments in which the present disclosure may be practiced as examples. These examples are described in detail to be sufficient for those skilled in the art to practice the present disclosure. It should be understood that the various embodiments of the present disclosure are different from each other but need not be mutually exclusive. For example, certain shapes, structures, and characteristics described herein may be implemented in other embodiments without departing from the spirit and scope of the present disclosure with respect to one embodiment. It should also be understood that the position or arrangement of individual components within each disclosed embodiment may be altered without departing from the spirit and scope of the present disclosure. Accordingly, the detailed description to be described below is not intended to be taken in a limited sense, and the scope of the present disclosure, if properly described, is limited only by the appended claims along with all the scope equivalent to those claimed by the claims. Similar reference numerals in the drawings refer to the same or similar functions across several aspects.

The components according to the present disclosure are components defined by functional classification rather than physical classification, and may be defined by functions performed by each. Each component may be implemented as hardware or a program code and a processing unit that perform each function, and functions of two or more components may be included in one component to be implemented. Accordingly, it should be noted that the names given to the components in the following embodiments are not intended to physically distinguish each component, but are given to imply a representative function in which each component is performed, and the technical spirit of the present disclosure is not limited by the names of the components.

Hereinafter, exemplary embodiments of the present disclosure will be described in more detail with reference to the drawings.

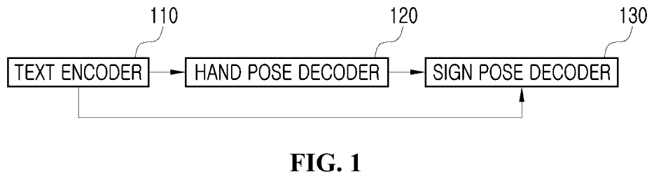

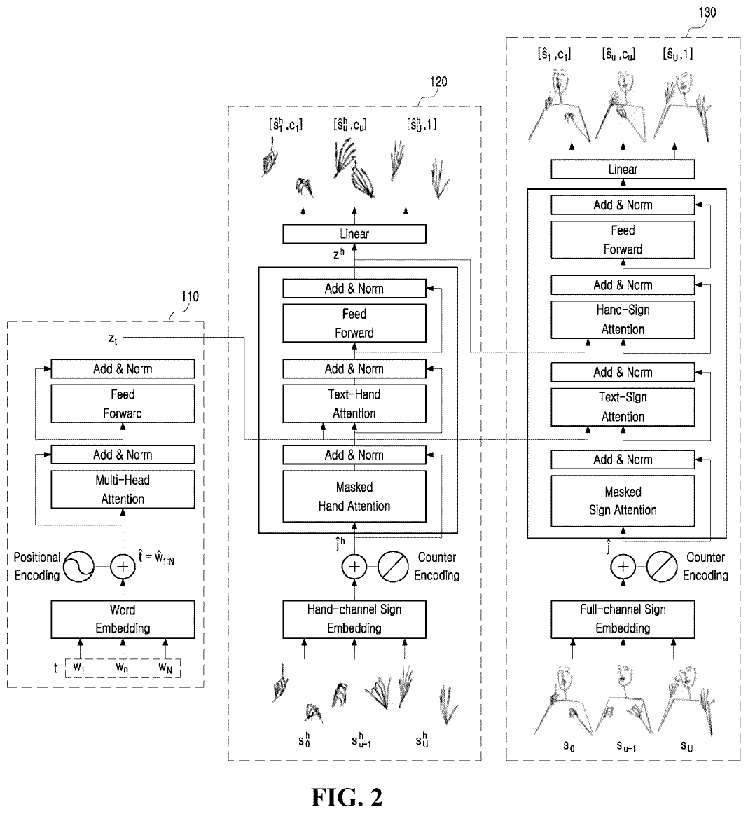

FIG. 1 is a device diagram illustrating an internal block of a cascade dual-decoder based sign language producing device according to an embodiment of the present disclosure, and FIG. 2 is a diagram illustrating a detailed configuration of the sign language producing device of FIG. 1.

The illustrated sign language producing device includes a text encoder 110, a hand pose decoder 120, and a sign pose decoder 130.

The text encoder 110 inputs a text sequence prepared in advance to at least one encoder block to output a contextual feature.

The hand pose decoder 120 inputs the contextual feature output from the text encoder 110 and a prepared hand pose sequence to at least one attention layer to output a hand-channel sign pose feature in which text and a hand motion are aligned.

The sign pose decoder 130 inputs the contextual features, the hand-channel sign pose features output from the text encoder 110 and the hand pose decoder 120 and a pre-prepared sign pose sequence to at least one attention layer, and outputs a full-channel sign pose sequence in which a sign language is expressed through a hand element and a non-hand element. Here, the hand element refers to an element related to a hand motion, and may include, for example, a hand shape, a location, an orientation, a movement, and the like. The non-hand element refers to an element that conveys the meaning of sign language by using a body part other than the hand, such as facial expressions, eye movements, head movements, mouth shapes, body movements, and the like may be included.

Referring to FIG. 2, the text encoder 110 includes at least one encoder block and learns context features of a text sequence. That is, the text encoder 110 word-embeds a text sequence t=w_{1:N} including at least one word, and generates a text sequence representation \hat{τ} by adding Positional Encoding (PE) to the word-embedded text sequence. Here, PE is derived from a predefined sinusoidal function, and indicates order information of words in a text sequence.

The text encoder 110 then generates a contextual feature zₜ which can be formulated as Equation 1 below through the stack of encoder blocks, where the text sequence representation is \hat{τ}=ŵ_{1:N}.

$${z}_{t} = Encoder ( {\hat{w}}_{n} \vert {\hat{w}}_{1 : N} ) \qquad Equation 1$$

The hand pose decoder 120 focuses on alignment between text and hand actions, which is main information indicating the morphological and grammatical structure of sign language.

Specifically, the hand pose decoder 120 generates a hand pose representation

$${\hat{J}}_{u}^{h}$$

by hand-channel sign embedding the hand pose sequence and adding Counter Encoding (CE) to the embedded hand pose sequence. Here, CE represents time information for inference of a hand channel sign pose (hand pose). The hand pose sequence refers to a 3D coordinate sequence for two hands, and may be, for example, a 3D coordinate sequence for 21 joints of the palm and finger of each hand.

Then, the hand pose decoder 120 inputs the hand pose representation

$${\hat{J}}_{u}^{h}$$

to a masked hand attention layer to model the hand pose representation, inputs the modeled result and the contextual feature from the text encoder 110 to a text-hand attention layer to model dependencies between the text sequence and the hand pose sequence, and inputs the modeled result and the contextual feature to a feed forward layer to generate a hand channel sign pose feature z^{h}. Here, the z^{h} is generated by applying a residual connection and a layer normalization, and the decoding process may be formulated as shown in Equation 2 below.

$${z}^{h} = {Decoder}_{h a n d} ( {\hat{J}}_{1 : u - 1} h , {z}_{t} ) \qquad Equation 2$$

The predicted 3D coordinates of the hand pose and the corresponding counter encoding

$$[ {\hat{s}}_{u}^{h} , {c}_{u} ]$$

are obtained directly through a linear transformation of the z^{h}, and the final output

$${\hat{s}}_{1 : U}^{h}$$

used to calculate the loss for optimizing the hand pose decoder 120.

The sign pose decoder 130 aims to generate a full-channel sign pose sequence including 3D coordinates of 120 keypoints. Here, the 120 key points include 70 facial landmarks, 42 hand joint points, 8 neck, shoulder, and arm joint points. The full channel refers to a channel including a hand channel for delivering a hand element and a non-hand channel for delivering a non-hand element.

The sign pose decoder 130 uses the contextual features of the text encoder 110 and the hand channel sign pose features of the hand pose decoder 120 as inputs and predicts a full channel sign pose sequence in an automatic regression manner.

Specifically, the sign pose decoder 130 generates a sign pose representation ju by performing full-channel sign embedding on the sign pose sequence and adding CE to the embedded sign pose sequence. Here, CE represents time information for full channel sign pose inference.

In addition, the Ju is supplied to a stack of decoder blocks and linear layers constituting the sign pose decoder 130 to generate a full channel sign pose sequence formulated as shown in Equation 3 below. That is, the sign pose decoder 130 models the sign pose representation by inputting the sign pose representation into a masked sign attention layer, and models the dependency between the text sequence and the sign pose sequence by inputting the modeled result and the contextual feature from the text encoder 110 into a text-sign attention layer.

$$[ {\hat{s}}_{u} , {c}_{u} ] = {Decoder}_{sign} ( {\hat{J}}_{1 : u - 1} , {z}_{1 : u - 1}^{h} , {z}_{t} ) \qquad Equation 3$$

Here, ŝᵤ refers to the full channel sign pose sequence generated for frame u and cᵤ is the corresponding counter encoding. Similar to hand pose decoder 120, the final output ŝᵤ is used to calculate the loss for optimizing sign pose decoder 130.

Meanwhile, directly predicting the full channel sign pose sequence presents the following problems. First, the average of a number of valid sign poses, i.e., blurred sign poses, results in incomplete generation in sign language production due to the regression to the average. Second, a single decoder that relies only on previous overall articulation prediction may accumulate errors in continuous prediction, resulting in problems such as misaligned hand positions and incorrect hand shapes.

To alleviate these problems, the hand-sign attention layer of the sign pose decoder 130 aligns the hand channel sign pose feature and the full channel sign pose feature, and outputs a combination matrix calculated by weighting V_{hand} with an attention value of Q_{sign} together with K_{hand} as shown in Equation 4 below.

$${h}^{HS} = soft max ( \frac{{Q}_{sign} {K}_{hand}^{T}}{\sqrt{{d}_{k}}} ) {V}_{hand} \qquad Equation 4$$

Here, K_{hand} and V_{hand} are hand channel features of a hand shape with dimensions (u-1) X dₖ obtained from the hand pose decoder 130. To prevent attending to the subsequent features, the frame representation after the current frame is masked. Q_{sign} is a feature of a full channel space of a hand shape (u-1) X dₖ obtained through a masked sign attention layer and a text-sign attention layer. dₖ represents the dimensionality of the hand pose decoder 120 or the sign pose decoder 130.

In this way, the sign pose decoder 130 inputs the dependency between the text sequence modeled through the text-sign attention layer and the sign pose sequence and the hand channel sign pose feature from the hand pose decoder 120 to the hand-sign attention layer to align the hand channel sign pose feature and the full channel sign pose feature, and inputs the aligned hand channel sign pose feature and the linear layer to generate the full channel sign pose sequence.

Meanwhile, the sign language transmits information through continuous operations of a continuous frame as well as a single frame of the sign language image. Accordingly, the present disclosure proposes a new loss function that balances spatial rotation and temporal continuity in order to effectively explore structural dependence in both space and time.

First, the spatial regression loss is obtained by the sum of the spatial regression loss of the hand pose decoder 120 and the spatial regression loss of the sign pose decoder 130 as shown in Equation 5 below.

$${L}_{Spatio} = {L}_{Spatio}^{H} + {L}_{Spatio}^{S} \qquad Equation 5$$

The spatial rotation loss

$${L}_{Spatio}^{H}$$

of the hand pose decoder 120 is the Mean Square Error (MSE) between the predicted hand pose sequence

$${\hat{s}}_{u}^{h}$$

and the ground truth

$${s}_{u}^{h} ,$$

and may be expressed as Equation 6 below.

$${L}_{Spatio}^{H} = \frac{1}{U} {\sum }_{i = 1}^{U} {( {s}_{1 : U}^{h} - {\hat{s}}_{1 : U}^{2} )}^{2} \qquad Equation 6$$

Similar to the hand pose decoder 120, the spatial rotation loss

$${L}_{Spatio}^{S}$$

of the sign pose decoder 130 is a MSE between the generated full channel sign pose sequence and an actual value, and may be represented by Equation 7 below.

$${L}_{Spatio}^{S} = \frac{1}{U} {\sum }_{i = 1}^{U} {( {s}_{1 : U} - {\hat{s}}_{1 : U} )}^{2} \qquad Equation 7$$

In order to verify the performance of space-time loss in various models, the present disclosure performs a pro-transformer including space-time loss, and in this case, the spatial session loss Lₛₚₐₜᵢₒ may be expressed as Equation 8 below.

$${L}_{Spatio} = {L}_{Spatio}^{S} \qquad Equation 8$$

Next, the temporal continuity loss is calculated as the MSE loss of the skeletal temporal distance matrix of the continuous frame between the predicted sign language sequence and the actual value. The skeletal temporal distance matrix of the sign pose sequence with the U frame may be formulated as shown in Equation 9 below.

$${D}^{st} ( s ) = {( [ {s}_{i} - {s}_{i - 1} ] )}^{2} , i ∈ [ 1 , U ] \qquad Equation 9$$

Here, the sign pose sᵢ represents the concatenation of 3D coordinates of all joints of the i-th frame, and ([ . . . ])² represents the square error matrix for each element of the sign pose between each frame and the previous frame. Here, each element represents a 3D coordinate value, and the skeletal temporal distance matrix shown in Equation 9 is used to measure the temporal distance between consecutive frames of the sign pose sequence.

Finally, the total time continuity loss is calculated as the sum of the time continuity losses of the hand pose decoder 120 and the sign pose decoder 130 as shown in Equations 10 to 12 below.

$${L}_{Temporal} = {L}_{Temporal}^{H} + {L}_{Temporal}^{S} \qquad Equation 10$$

$${L}_{Temporal}^{H} = \frac{1}{U - 1} {\sum }_{i = 2}^{U} {( {D}_{1 : U}^{st} ( {s}^{h} ) - {D}_{1 : U}^{st} ( {\hat{s}}^{h} ) )}^{2} \qquad Equation 11$$

$${L}_{Temporal}^{S} = \frac{1}{U - 1} {\sum }_{i = 2}^{U} {( {D}_{1 : U}^{st} ( s ) - {D}_{1 : U}^{st} ( \hat{s} ) )}^{2} \qquad Equation 12$$

Here,

$${L}_{Temporal}^{H}$$

is calculated by the temporal distance between the predicted hand pose sequence and the actual value, and

$${L}_{Temporal}^{S}$$

is calculated by the temporal distance between the predicted full channel sign pose sequence and the actual value.

Therefore, the final spatiotemporal loss function used in the training of the sign language producing device proposed in the present disclosure is as shown in Equation 13 below. That is, the space-time loss function is obtained as a combination of Lₛₚₐₜᵢₒ and L_{Temporal}.

$${L}_{ST} = α {L}_{Spatio} + λ {L}_{Temporal} \qquad Equation 13$$

Here, α represents the weight of the spatial regression loss, and A represents the weight of the temporal continuity loss.

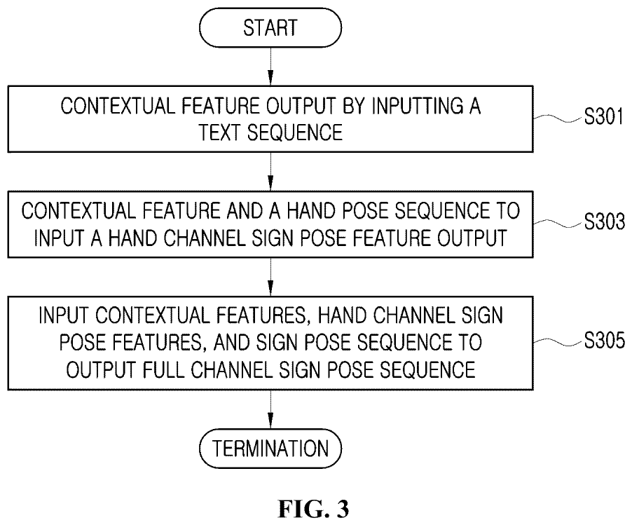

FIG. 3 is a flowchart illustrating an operation of a sign language producing device based on a cascade dual-decoder according to the other embodiment of the present disclosure.

The text encoder of the sign language producing device outputs contextual features by inputting a pre-prepared text sequence into at least one encoder block. (S301)

The hand pose decoder of the sign language producing device inputs the contextual feature output from the text encoder and a pre-prepared hand pose sequence to at least one or more attention layers to output a hand channel sign pose feature in which the text and the hand motion are aligned. (S303)

Thereafter, the sign pose decoder of the sign language producing device inputs the contextual feature and the hand channel sign pose feature output from the text encoder and the hand pose decoder and a pre-prepared sign pose sequence to at least one attention layer, and outputs a full channel sign pose sequence in which the sign language is represented by a hand element related to a hand operation and a non-hand element for transferring the meaning of sign language using a body part other than the hand. (S305)

The cascade dual-decoder based sign language producing method according to the present disclosure may be implemented in the form of program instructions that may be executed through various computer components and recorded in a computer-readable recording medium. The computer-readable recording medium may include program instructions, data files, data structures, and the like alone or in combination.

The program instructions recorded in the computer-readable recording medium may be specially designed and configured for the present disclosure or may be known to and used by those skilled in the field of computer software.

Examples of the computer-readable recording medium include a magnetic medium such as a hard disk, a floppy disk, and a magnetic tape, an optical recording medium such as a CD-ROM and a DVD, a magneto-optical medium such as a floptical disk, and a hardware device specially configured to store and execute program instructions such as a ROM, a RAM, a flash memory, and the like.

Examples of program instructions include not only machine language codes such as those generated by a compiler, but also high-level language codes that may be executed by a computer using an interpreter or the like. The hardware device may be configured to operate as one or more software modules to perform processing according to the present disclosure, and vice versa.

Although various embodiments of the present disclosure have been illustrated and described above, the present disclosure is not limited to the specific embodiments described above, and various modifications can be made by a person skilled in the art to which the present disclosure belongs without departing from the gist of the present disclosure claimed in the claims, and such modifications should not be individually understood from the technical spirit or the prospect of the present disclosure.

### DESCRIPTION OF SYMBOLS

110: Text encoder
120: Hand pose decoder
130: Sign pose decoder

1. A cascade dual-decoder based sign language producing device comprising:
a text encoder configured to input a text sequence prepared in advance into at least one encoder block to output a contextual feature;
a hand pose decoder configured to input the contextual feature output from the text encoder and a hand pose sequence prepared in advance into at least one attention layer to output a hand-channel sign pose feature that aligns text and hand motions; and
a sign pose decoder configured to input the contextual feature output from the text encoder and the hand pose decoder, the hand-channel sign pose feature, and a sign pose sequence prepared in advance into the at least one attention layer to output a full-channel sign pose sequence, wherein a sign language is implemented as a hand element and a non-hand element.

2. The cascade dual-decoder based sign language producing device of claim 1, wherein
the text encoder is configured to generate a text sequence representation by performing a word-embedding on the text sequence and adding a Positional Encoding (PE) corresponding to the word-embedded text sequence, and
the PE is derived from a predefined sinusoidal function.

3. The cascade dual-decoder based sign language producing device of claim 1, wherein
the hand pose decoder is configured to generate a hand pose representation by performing a hand-channel sign embedding on the hand pose sequence and adding a Counter Encoding (CE) to the embedded hand pose sequence, and
the CE represents time information for a hand-channel sign pose inference.

4. The cascade dual-decoder based sign language producing device of claim 3, wherein the hand pose decoder is further configured to:
input the hand pose representation into a masked hand attention layer to model the hand pose representation,
input the modeled hand pose representation and the contextual feature from the text encoder into a text-hand attention layer to model dependencies between the text sequence and the hand pose sequence, and
input the modeled dependencies and the contextual feature into a feed forward layer to generate the hand-channel sign pose feature.

5. The cascade dual-decoder based sign language producing device of claim 1, wherein
the sign pose decoder is configured to generate a sign pose representation by performing a full-channel sign embedding on the sign pose sequence and adding a Counter Encoding (CE) to the embedded sign pose sequence, and
the CE represents time information for a full-channel sign pose inference.

6. The cascade dual-decoder based sign language producing device of claim 5, wherein the sign pose decoder is configured to:
model the sign pose representation by inputting the sign pose representation into a masked sign attention layer,
model dependencies between the text sequence and the sign pose sequence by inputting the modeled sign pose representation and the contextual feature from the text encoder into a text-sign attention layer,
align the hand-channel sign pose feature and a full-channel sign pose feature by inputting the modeled dependencies and the hand-channel sign pose feature from the hand pose decoder into a hand-sign attention layer, and
generate the full-channel sign pose sequence by inputting the aligned hand-channel sign pose feature and the full-channel sign pose feature into a feed forward layer and a linear layer.

7. The cascade dual-decoder based sign language producing device of claim 1,
wherein the cascade dual-decoder based sign language producing device is trained through a space-time loss function, and
wherein the space-time loss function is derived from a sum of a spatial regression loss and a temporal continuity loss for each of the hand pose decoder and the sign pose decoder.

8. A sign language producing method by a cascade dual-decoder-based sign language producing device, the sign language producing method comprising:
inputting, by a text encoder, a text sequence prepared in advance into at least one encoder block to output contextual feature;
inputting, by a hand pose decoder, the contextual feature output from the text encoder and a hand pose sequence prepared in advance into at least one attention layer to output a hand-channel sign pose feature that aligns text and hand motions; and
inputting, by a sign pose decoder, the contextual feature output from the text encoder and the hand pose decoder, the hand-channel sign pose feature, and a sign pose sequence prepared in advance into the at least one attention layer to output a full-channel sign pose sequence, a sign language is implemented as hand element and a non-hand element.

9. The sign language producing method of claim 8, wherein the outputting of the contextual feature comprises: generating a text sequence representation by performing a word-embedding on the text sequence and adding a Positional Encoding (PE) corresponding to the word-embedded text sequence, and
wherein the PE is derived from a predefined sinusoidal function.

10. The sign language producing method of claim 8, wherein the outputting of the hand-channel sign pose feature comprises: generating a hand pose representation by performing a hand-channel sign embedding on the hand pose sequence and adding a Counter Encoding (CE) to the embedded hand pose sequence, and
wherein the CE represents time information for a hand-channel sign pose inference.

11. The sign language producing method of claim 10, wherein the outputting of the hand-channel sign pose feature further comprises:
inputting the hand pose representation into a masked hand attention layer to model the hand pose representation,
inputting the modeled hand pose representation and the contextual feature from the text encoder into a text-hand attention layer to model dependencies between the text sequence and the hand pose sequence, and
inputting the modeled dependencies and the contextual feature into a feed forward layer to generate the hand-channel sign pose feature.

12. The sign language producing method of claim 8, wherein the outputting of the full-channel sign pose sequence comprises: generating a sign pose representation by performing a full-channel sign embedding on the sign pose sequence and adding a Counter Encoding (CE) to the embedded sign pose sequence, and
wherein the CE represents time information for a full-channel sign pose inference.

13. The sign language producing method of claim 12, wherein the outputting of the full-channel sign pose sequence further comprises:
modeling the sign pose representation by inputting the sign pose representation into a masked sign attention layer,
modeling dependencies between the text sequence and the sign pose sequence by inputting the modeled sign pose representation and the contextual feature from the text encoder into a text-sign attention layer,
aligning the hand-channel sign pose feature and a full-channel sign pose feature by inputting the modeled dependencies and the hand-channel sign pose feature from the hand pose decoder into a hand-sign attention layer, and
generating the full-channel sign pose sequence by inputting the aligned hand-channel sign pose feature and the full-channel sign pose feature into a feed forward layer and a linear layer.

14. The sign language producing method of claim 8,
wherein the cascade dual-decoder-based sign language producing device is trained through a space-time loss function, and
wherein the space-time loss function is derived from a sum of a spatial regression loss and a temporal continuity loss for each of the hand pose decoder and the sign pose decoder.

15. A recording medium having recorded thereon a computer program for performing a sign language producing method by a cascade dual-decoder-based sign language producing device, wherein the sign language producing method comprises:
inputting, by a text encoder, a text sequence prepared in advance into at least one encoder block to output contextual feature;
inputting, by a hand pose decoder, the contextual feature output from the text encoder and a hand pose sequence prepared in advance into at least one attention layer to output a hand-channel sign pose feature that aligns text and hand motions; and
inputting, by a sign pose decoder, the contextual feature output from the text encoder and the hand pose decoder, the hand-channel sign pose feature, and a sign pose sequence prepared in advance into the at least one attention layer to output a full-channel sign pose sequence, a sign language is expressed by a hand element and a non-hand element.
